(19) United States
(12) Patent Application Publication
(10) Pub. No.: US 2006/0095948 A1
(43) Pub. Date: May 4, 2006

(54) Channel tapping in a near-video-on-demand system

(75) Inventors: Wilhelmus Franciscus Verhaegh, Eindhoven (NL); Ronald Rietman, Eindhoven (NL); Johannes Henricus Maria Korst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.V.

(21) Appl. No.: 10/536,639

(22) PCT Filed: Nov. 6, 2003
(86) PCT No.: PCT/IB03/05075

§ 371 Date: May 27, 2005

(30) Foreign Application Priority Data
Dec. 6, 2002 (EP) 02080101.5

(51) Int. Cl. H04N 7/173

(52) U.S. Cl. 725/101; 725/103

(57) ABSTRACT

In a broadcast system 100 a broadcasting device broadcasts titles using a near-video-on-demand broadcasting protocol. Data blocks of a title are broadcast via c parallel equal capacity channels of the broadcast system. The broadcast channels 160 including time-sequentially interleaved sub-channel(s). The title is divided in a plurality of consecutive data block sequences. Each block sequence is assigned to one respective sub-channel. The broadcasting device repeatedly broadcasts each block sequence in the assigned sub-channel. The broadcast receiver 150 has a capacity to simultaneously receive all sub-channels of a plurality r (1i, the receiver terminates reception of the sub-channel in channel i and starts reception of at least one sub-channel of channel r+i.

### FIELD OF THE INVENTION

The invention relates a broadcast system for broadcasting data streams to a plurality of broadcast receivers through a communication system. The invention further relates to a broadcast receiver for use in such a system. The invention also relates to a method of receiving a broadcast title.

### BACKGROUND OF THE INVENTION

Conventional digital broadcasting systems, such as cable networks, terrestrial broadcast networks or satellite networks, have a capacity in the order of one gigabit per second downstream (i.e. in the direction from a central broadcaster towards the broadcast receiver). Some of this capacity is reserved for conventional broadcast channels, like the most popular television stations. Such channels can in principle be received by all broadcast receivers (i.e. it is transmitted via all coax cables), although actual receipt may be conditional upon payment. A small part of the bandwidth may be reserved for upstream communication from the broadcast receiver up through the network to an interested party outside the network. Usually, this upstream communication is to the Internet, using broadband cable modems. It may also be to a service provider for interactive applications. With the remaining bandwidth, it is difficult if not infeasible to provide an effective video-on-demand service where a significant portion of the receivers can simultaneously receive a title (e.g. movie) whose supply is started substantially immediately after the user having indicated that it wishes to receive the title. To overcome this, so-called near-video-on demand broadcast distribution protocols have been developed wherein a title is repeatedly broadcast using a group of a plurality of broadcast channels. A highly effective protocol is the Pagoda broadcasting protocol described in “A fixed-delay broadcasting protocol for video-on-demand”, of J.-F. Pâris, Proceedings of the 10^{th} International Conference on Computer Communications and Networks, pages 418-423. In this protocol, a title is repeatedly broadcast using c parallel broadcast channels of the broadcast system. The channels have equal transmission capacity. The first channel is used for repeatedly transmitting only the first blocks of the title. In this way, a receiver can relatively quickly receive the first blocks of the title. Subsequent channels are used for transmitting other sequences of blocks of the title.

Each channel repeatedly broadcasts blocks from the same sequence. The number of different blocks allocated to a channel increases with the channel number. For continuous playback of a received title, the broadcast receiver needs to tap into (receive) r channels at the same time (1<r≦c), typically r=2. The broadcast receiver starts by tapping the lowest r channels. Playback of the title can start as soon as the first block has been received. If the system is used with an offset, then the receiver must also wait the additional time specified by the offset before starting playback. Each time it has received all blocks of the block sequence assigned to channel i it terminates reception of channel i and starts reception of channel r+i until all block sequences of the title have been received. Since the receiver simultaneously receives several block sequences, it needs to temporarily buffer some blocks and re-order them for playback. To optimize the order in which blocks are transmitted in a channel, the channels are subdivided into equal capacity sub-channels. If no offset is used, the first and second channel can be seen as having only one sub-channel. The number of sub-channels in a channel is equal to or higher than the number of sub-channels in the previous channel. A channel is formed by time-sequentially interleaving the sub-channels of a channel. The title is divided into consecutive sequences of blocks. Each sequence is assigned to one respective sub-channel according to the channel number and sub-channel number within the channel. Typically, the number of blocks in the sequence increases with the channel number and sub-channel number.

For practical implementations of the Pagoda system, the number of channels c needs to be kept relatively low (e.g. c=1) to be able to simultaneously broadcast a reasonable number of titles. To keep the costs of the broadcast receiver low, also the number of channels that can be received simultaneously (and consequently the buffer size) needs to be kept relatively low (e.g. r=2). According to the Pagoda broadcasting protocol, this results in relatively large block sizes. This has a negative influence on the response time of the system (i.e. the time from the instruction of the user to view a title until playback of the title actually begins).

### SUMMARY OF THE INVENTION

It is an object of the invention to provide a near-video-on-demand broadcast system using a Pagoda-like broadcasting protocol that provides a better response time.

To meet the object of the invention, a broadcast system for broadcasting titles to a plurality of broadcast receivers uses a near-video-on-demand broadcasting protocol wherein data blocks of a title are broadcast via c parallel, equal capacity channels of the broadcast system, where each broadcast channel is associated with a respective sequential channel number; a plurality of the broadcast channels including a plurality of time-sequentially interleaved sub-channels; the number of sub-channels in a channel being monotonous non-decreasing with the channel number; the sub-channels in a channel being associated with a respective sequential sub-channel number; the title being divided in a plurality of consecutive data block sequences; each block sequence being assigned to one respective sub-channel according to the channel number and sub-channel number; each sub-channel repeatedly broadcasting the assigned block sequence; the broadcast receiver having a capacity to simultaneously receive all sub-channels of a plurality r (1<r≦c) channels; the broadcast receiver being operative to receive a title by starting reception of all sub-channels of the sequentially lowest r channels and each time in response to having received all blocks of the block sequence of a sub-channel of channel i terminate reception of the sub-channel in channel i and start reception of at least one sub-channel of channel r+i until all block sequences have been received.

The inventors have realized that in the conventional Pagoda schedule reception capacity of the broadcast receiver is wasted. A channel is tapped until all blocks of all sub-channels of the channel have been received once. Particularly, since the length of the sub-channels tends to increase, all blocks of the lowest sub-channels in a channel are usually received well before the last block of the highest sub-channel of the channel has been received. Since all sub-channels are repeatedly transmitted and interleaved, this implies that after the lowest sub-channel has been received, some time-slots contain no new data blocks any more. In the known system, the time-multiplexed data stream of a channel is fully received until the last block has been received once. In the system according to the invention, as soon as all blocks of a sub-channel in channel i have been received the receiver starts tapping at least one sub-channel of channel i+r. It should be noted that as long as not all sub-channels of channel i have been received, the receiver also still taps channel i. During time-slots used for transmitting blocks of an already received sub-channel of channel i, the receiver now receives blocks of a sub-channel of channel i+r. Thus, the receiver taps more than r channels in the sense that it receives and stores blocks of more than r channels. However, at any moment of time it only receives blocks of r channels. In this way the reception capacity is used better. Since the block sizes and the broadcast schedule are chosen in such a way that by tapping all sub-channels of r channels no underflow of the playback buffer occurs, the effectively increased reception capacity makes it possible to decrease the block size, and as such enables a shorter response time. In a practical system with r=2, c=11, the response time can be almost halved.

As described by the measure of the dependent claim 2, the data blocks assigned to the parallel channels are broadcast synchronously using equal-duration time slots; each sub-channel of channel i being associated with at least one sub-channel of channel r+i whose blocks are only being broadcast during time-slots used for broadcasting the associated sub-channel of channel i; the broadcast receiver being operative, in response to having received all blocks of the block sequence of a sub-channel of channel i, to start reception of an associated sub-channel of channel r+i (i≧1). By ensuring that for (preferably for each) a sub-channel of channel i there is a sub-channel of channel i+r that uses the same time-slots (i.e. is transmitted using the same phase) and by associating these channels, as soon as all blocks of the sub-channel of channel i have been received reception of the associated sub-channel of channel i+r can start.

As described by the measure of the dependent claim 3, channel i+r has a multiple Mᵢ of sub-channels of the number of sub-channels in channel i; each sub-channel of channel i being associated with Mᵢ sub-channels of channel r+i whose blocks are only being broadcast during time-slots used for broadcasting the associated sub-channel of channel i; the broadcast receiver being operative in response to having received all blocks of the block sequence of a sub-channel of channel i start reception of the Mᵢ associated sub-channels of channel r+i (i≧1). By dividing channel i+r into a number of sub-channels that is a multiple Mᵢ of the number of sub-channels of channel i, each time a sub-channel of channel i has been fully received, reception of Mᵢ sub-channels of channel i+r can start. In this way, reception capacity is fully exploited.

These and other aspects of the invention are apparent from and will be elucidated with reference to the embodiments described hereinafter.

### BRIEF DESCRIPTION OF THE DRAWINGS

In the drawings:

FIG. 1 shows an exemplary hierarchical broadcast network in which the invention can be employed;

FIG. 2 shows block diagram of the broadcast system according to the invention;

FIGS. 3A and 3B illustrate the Pagoda NVoD protocol;

FIG. 4 illustrates adding a channel in the Pagoda protocol;

FIG. 5 illustrates the unused reception capacity in the original Pagoda protocol; and

FIG. 6 illustrates the reception schedule according to the invention.

### DETAILED DESCRIPTION OF THE PREFERRED EMBODIMENT

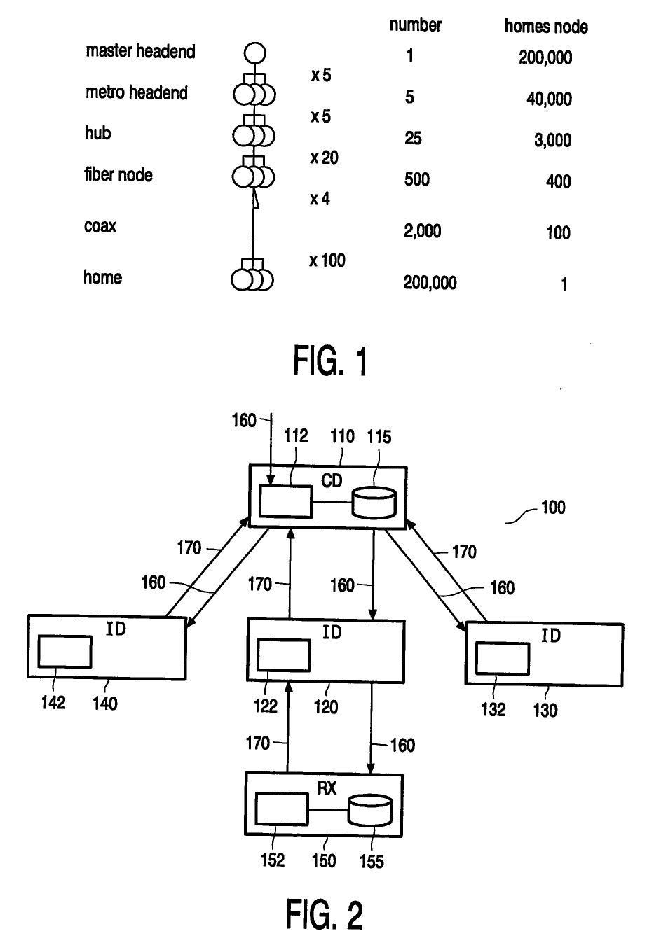

FIG. 2 shows a block diagram of the broadcast system in which the near-video-on-demand (NVoD) protocol according to the invention may be employed. The exemplary broadcast system 100 includes a hierarchical network of data distributors. The top of the network is formed by a central distributor 110. The system includes at least one layer of intermediate distributors. To simply the figure, only one intermediate layer for downstream broadcasting is shown with three intermediate distributors 120, 130 and 140, each covering a disjoint geographical area. FIG. 1 shows a typical hierarchical network for a town of 200,000 connected homes, with four intermediate downstream layers (metro headend, hub, fiber node, coaxial headend). FIG. 2 also indicates the downstream path 160 that starts at the central distributor 110, runs through the intermediate distributors 120, 130 and 140 and ends at the plurality of broadcast receivers of the system. Conventionally the distributors split the broadcast signal towards the receivers/distributors that are hierarchically one layer lower. For simplicity only one broadcast receiver 150 is shown. Typically, the path is divided into a plurality of channels, that each may be sub-divided into sub-channels. At the lowest level, usually coaxial segments are used that formed a shared medium to the broadcast receivers. On coax, channels are usually frequency multiplexed. Sub-channels within such a channel may be time-multiplexed. At the higher levels, typically fiber optics is used. On such media, channels may also be time-multiplexed. Any suitable transmission technology, such as various types of media and multiplexing techniques, may be used. The broadcast system is described for broadcasting digital data streams through the network to the plurality of broadcast receivers. The data streams may have been encoded using any suitable technology, such as MPEG2 video encoding. Broadcast data is not addressed to a specific receiver and can in principle be received by all receivers in all segments of the hierarchical network. Access to the data may be subject to payment. In the broadcast system according to the invention access may also be controlled using suitable conditional access mechanisms. For each device of the system, FIG. 2 schematically shows the respective hardware/software functionality 112, 122, 132, 142 and 152 necessary for sending/receiving broadcast data and performing all necessary processing. In itself such HW/SW is known and can be used for the system according to the invention. The HW/SW may be formed by suitable transceivers (such as fiber optics transceiver and/or cable modems) controlled by using suitable processors, such as signal processors. Also dedicated hardware, like MPEG encoders/decoders, buffers, etc. may be used.

Typically, all data streams are inserted by the central distributor 110 and unmodified copied by each intermediate layer to the lowest part of the network. To this end, the central distributor may have a storage 115 for storing a plurality of titles, such as movies. It may also have a connection 160 for receiving live broadcasts, e.g. through satellite connections. The storage may be implemented on suitable server platforms, for example based on RAID systems. The receiver also has access to a storage 155. This storage may also be formed by a hard disk or solid state memory, such as RAM of flash memory. The storage is used for (temporarily or permanently) storing the entire title or part of the title received via the downstream channels before the title is rendered. FIG. 2 also shows an upstream channel 170 of the network towards the central distributor. In principle, the upstream channel may start at an intermediate level going upwards. Preferably, the upstream channel is already present at the lowest level, also allowing communication to outside the broadcast system (e.g. towards the Internet via the central distributor or an intermediate distributor outwards). It will be appreciated that instead of using a multi-tier hierarchical network as shown in FIGS. 1 and 2 also a network may be used wherein data is broadcast directly form the central distributor to the receivers. It will also be understood that instead of using wired connection also wireless connections may be used, for example using satellite broadcast, digital terrestrial broadcast or using high bandwidth telecommunication networks.

The NVoD protocols according to the invention will be described with reference to the Pagoda broadcasting protocol. To this end, first the latter protocol will be described in more detail.

Fixed-delay Pagoda Broadcasting

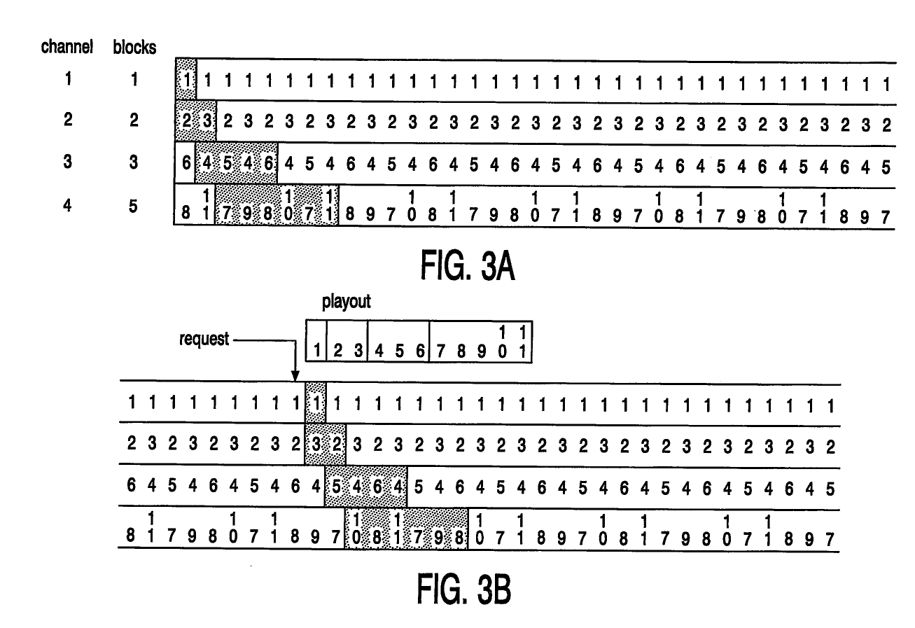

Preferably, the fixed-delay pagoda broadcasting protocol is used as the near-video-on-demand protocol for broadcasting data blocks of the titles. This protocol is asymptotically optimal, and it can easily be adapted to limited client I/O bandwidth. A small example of this is given in FIG. 3A. FIG. 3B shows how the retrieval takes place for a request at an arbitrary moment. In the example of FIG. 3, at most two channels are tapped at the same time, and all blocks arrive in time. Key in this NVoD scheme is that channel i starts being tapped after the tapping of channel i-2 has finished, thereby limiting the number of channels to be tapped to two. This means e.g. that for channel 4 a receiver has to wait two time units before it can start tapping the channel. As block 7 has to be received within 7 time units after the request, this means that only 5 time units are left to receive it, and hence it has to be transmitted with a period of at most 5, rather than 7. It is actually transmitted with a period of 4. The general structure of the above broadcast scheme will be described for a given number c of server channels and a given number r of client channels that can be received. Furthermore, an offset o is considered as described meaning that a user will always wait an additional o time units before playing out. The start of the (tapping) segment in channel i is denoted by sᵢ, and the end by eᵢ. Then, in order not to exceed the maximum number r of channels that a user can receive, tapping in channel i=r+1, . . . , c is started after the tapping in channel i-r has ended. Hence

$${s}_{1} = \{ \begin{matrix}1 & for i = 1 , … r \\ {e}_{i - r} + 1 & for i = r + 1 , … , c\end{matrix}$$

Next, in channel i blocks lᵢ, . . . ,hᵢ are transmitted. The number of different blocks transmitted in channel i is hence given by nᵢ=hᵢ−lᵢ+1, and

$${l}_{i} = \{ \begin{matrix}1 & for i = 1 \\ {h}_{i} + 1 & for i > 1\end{matrix}$$

In order to receive each block in time, block k is to be transmitted in or before time unit o+k. If block k is transmitted in channel i, which starts being received in time unit sᵢ, this means that block k should be broadcast with a period of at most o+k−(sᵢ−1). Ideally, this period is exactly met for each block k, but it is sufficient to get close enough.

The structure of channel i in the pagoda scheme is as follows. First, channel i is divided into a number dᵢ of sub-channels, which is given by
dᵢ=[\sqrt{o+lᵢ−(sᵢ−1)}] (1)
i.e., the square root of the optimal period of block lᵢ, rounded to the nearest integer. Each of these sub-channels gets a fraction 1/dᵢ of the time units to transmit blocks, in a round-robin fashion. In other words, in time unit t sub-channel t mod dᵢ can transmit a block, where we number the sub-channels 0, 1, . . . , dᵢ-1.

Now, if a block k is given a period pₖ within a sub-channel of channel i, it is broadcasted in channel i with a period of pₖdᵢ. Hence, to obtain that pₖdᵢ≦o+k−(sᵢ−1), this means that

$${p}_{k} \leq [ \frac{o + k - ( {s}_{i} - 1 )}{{d}_{i}} ]$$

By taking equal periods for all blocks within each sub-channel, collisions can be trivially avoided. So, if lᵢⱼ is the lowest block number in sub-channel j of channel i, this means that the following period is chosen

$${p}_{ij} = ⌊ \frac{o + {l}_{ij} - ( {s}_{i} - 1 )}{{d}_{i}} ⌋$$

for all blocks within sub-channel j of channel i, and hence we can transmit nᵢⱼ=pᵢⱼ blocks (blocks lᵢⱼ, . . . lᵢⱼ+nᵢⱼ−1) in this sub-channel. The block number lᵢⱼ is given by

$${l}_{ij} = \{ \begin{matrix}{l}_{i} & for j = 0 \\ {l}_{i , j - 1} + {n}_{i , j - 1} & for j > 1\end{matrix}$$

The total number nᵢ of blocks transmitted in channel i is then given by

$${n}_{i} = {\sum }_{j = 0}^{{d}_{i} - 1} {n}_{ij}$$

with which we can compute hᵢ=lᵢ+nᵢ−1.

Finally, the moment of start and end of the segments within a channel is reviewed. All sub-channels of channel i start transmitting at time sᵢ. Sub-channel j of channel i is ready after nᵢⱼ blocks, which takes dᵢ nᵢⱼ time units within channel i. Hence, the end of the segment in sub-channel j is given by eᵢⱼ=sᵢ−1+dᵢnᵢⱼ, and channel i ends when its last sub-channel ends, at
eᵢ=e_{i,d}_{ₗ}₋₁=sᵢ−1+dᵢn_{i,d}_{ₗ}₋₁

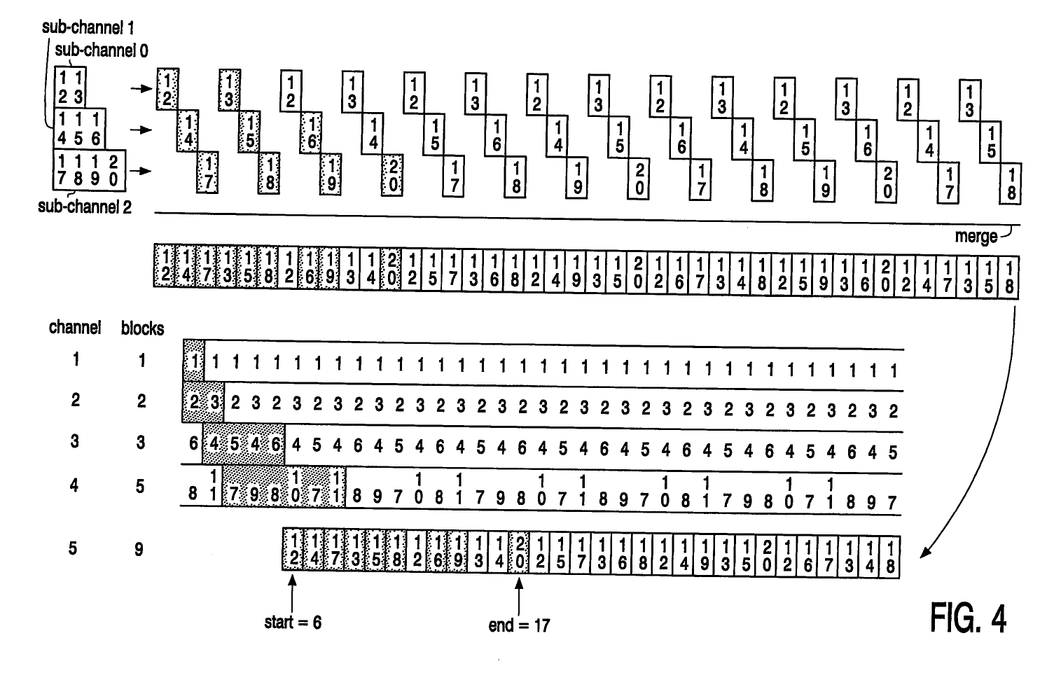

To exemplify the above, FIG. 4 illustrates adding a fifth channel to the example of FIG. 3 . For the fifth channel, the following holds: l₅=12, s₅=e₃+1 =6, and an offset o=O. The number of sub-channels is d₅=[√(0+12−5)]=3. For sub-channel j=0 this gives l_{5,0}=12, hence we can transmit n_{5,0}=└(0+12−5)/3┘=2 blocks in this sub-channel, being blocks 12 and 13. For sub-channel j=1 this gives l_{5,1} =14, hence we can transmit n_{5,1}=└(0+14−5)/3┘=3 blocks in this sub-channel, being blocks 14, 15, and 16. For sub-channel j=2 this gives l_{5,2}=17, hence we can transmit n_{5,2}=└(0+17−5)/ 3┘=4 blocks in this sub-channel, being blocks 17, 18, 19 , and 20. The end of the segments in the sub-channels are given by e_{5,0}=5+3*2=11, e_{5,1}=5+3*3=14, and e_{5,2}=5+3*4=17, hence e₅=17.

The values of hᵢ, i.e., the number of blocks in which a movie can be split, are given in table 1 for an offset zero and for different values of r. The series converge to power series, with bases of about 1.75, 2.42, 2.62, and e≈2.72, for r=2, 3, 4, and ∞ respectively.

TABLE 1

| | r = 2 | r = 3 | r = 4 | r = ∞ |
|---|---|---|---|---|
| i = 1 | 1 | 1 | 1 | 1 |
| i = 2 | 3 | 3 | 3 | 3 |
| i = 3 | 6 | 8 | 8 | 8 |
| i = 4 | 11 | 17 | 20 | 20 |
| i = 5 | 20 | 39 | 47 | 50 |
| i = 6 | 38 | 86 | 113 | 124 |
| i = 7 | 68 | 198 | 276 | 316 |
| i = 8 | 122 | 467 | 692 | 822 |
| i = 9 | 221 | 1102 | 1770 | 2176 |
| i = 10 | 397 | 2632 | 4547 | 5818 |
| i = 11 | 708 | 6308 | 11800 | 15646 |
| i = 12 | 1244 | 15192 | 30748 | 42259 |
| i = 13 | 2195 | 36672 | 80273 | 114420 |
| i = 14 | 3862 | 88710 | 210027 | 310284 |
| i = 15 | 6757 | 214792 | 549998 | 842209 |

The last column corresponds to having no limit on the number of client channels. Using the above values of h_{c}, the maximum waiting time is given by a fraction 1/h_{c}, of the movie length when using c channels. If a positive offset o is used, the general formula for the maximum waiting time is a fraction (o+1)/h_{c} of the movie length.

In the previous sections, the number dᵢ of sub-channels of channel i is fixed, given by equation (1). It should be noted that also different values may be used to get a better solution in terms of the number of blocks into which a movie can be split. To this end, a first-order optimization can be applied by exploring per channel i a number of different values around the target value given in (1), calculating the resulting number of blocks that can be fit into channel i, and taking the number of sub-channels for which channel i can contain the highest number of blocks. Note that this is done per individual channel, i.e., no back-tracking to previous channels occurs, to avoid an exponential run time for a straightforward implementation. This may lead to sub-optimal solutions, as choosing a different number of sub-channels in channel i to get a higher number of blocks in it may cause the end time eᵢ to increase, thereby increasing the start time sᵢ₊ᵣ of channel i+r, which may in turn decrease the number of blocks that can be fit into this channel. Nevertheless, this first-order optimization gives good results as is shown in table 2. The new values of hᵢ are given for an offset zero and for different values of r. Although the numbers are higher than the ones in the previous table, the bases of the power series are the same as those of table 1.

TABLE 2

| | r = 2 | | r = 3 | | r = 4 | | r = ∞ | |
|---|---|---|---|---|---|---|---|---|
| i = 1 | 1 | | 1 | | 1 | | 1 | |
| i = 2 | 3 | | 3 | | 3 | | 3 | |
| i = 3 | 6 | | 8 | | 8 | | 8 | |
| i = 4 | 11 | | 18 | (+1) | 20 | | 20 | |
| i = 5 | 21 | (+1) | 41 | (+2) | 47 | | 50 | |
| i = 6 | 42 | (+4) | 94 | (+8) | 115 | (+2) | 127 | (+3) |
| i = 7 | 81 | (+13) | 218 | (+20) | 287 | (+11) | 328 | (+12) |
| i = 8 | 148 | (+26) | 510 | (+43) | 728 | (+36) | 859 | (+37) |
| i = 9 | 269 | (+48) | 1213 | (+111) | 1868 | (+98) | 2283 | (+107) |
| i = 10 | 478 | (+81) | 2908 | (+276) | 4831 | (+284) | 6112 | (+294) |
| i = 11 | 841 | (+133) | 6993 | (+685) | 12543 | (+743) | 16459 | (+813) |
| i = 12 | 1487 | (+243) | 16869 | (+1677) | 32685 | (+1937) | 44484 | (+2225) |
| i = 13 | 2627 | (+432) | 40749 | (+4077) | 85391 | (+5118) | 120485 | (+6065) |
| i = 14 | 4617 | (+755) | 98625 | (+9915) | 223390 | +13363) | 326795 | +16511) |
| i = 15 | 8058 | (+1301) | 238841 | (+24049) | 584993 | (+34995) | 887124 | (+44915) |

In the remainder, the values of table 1 for the conventional Pagoda protocol will be used.

In the description so far, it has been assumed that titles have a constant bit rate (CBR). The transmission schemes, however, can easily be adapted to cope with variable bit rate (VBR) streams. The time at which block k must have arrived, which is given by o+k for CBR streams, is then given by a function o+t(k). Here, t(k) is an increasing function, that describes the way the stream is to be played out in time. The effect on the transmission scheme is as follows. If block k is transmitted in channel i, which starts at time sᵢ, then it must be broadcasted with a period of at most o+t(k)−(sᵢ−1). Hence, the target value for the number of sub-channels, as given in equation (1), now becomes
dᵢ=└\sqrt{o+t(lᵢ)−(sᵢ−1)}┘

The number of blocks in sub-channel j of channel i, i.e., the period used within this sub-channel, is then given by

$${n}_{ij} = {p}_{ij} = ⌊ \frac{o + t ( {l}_{ij} ) - ( {s}_{i} - 1 )}{{d}_{i}} ⌋ .$$

The rest of the computations remain the same.

Sub-channel Tapping According to the Invention

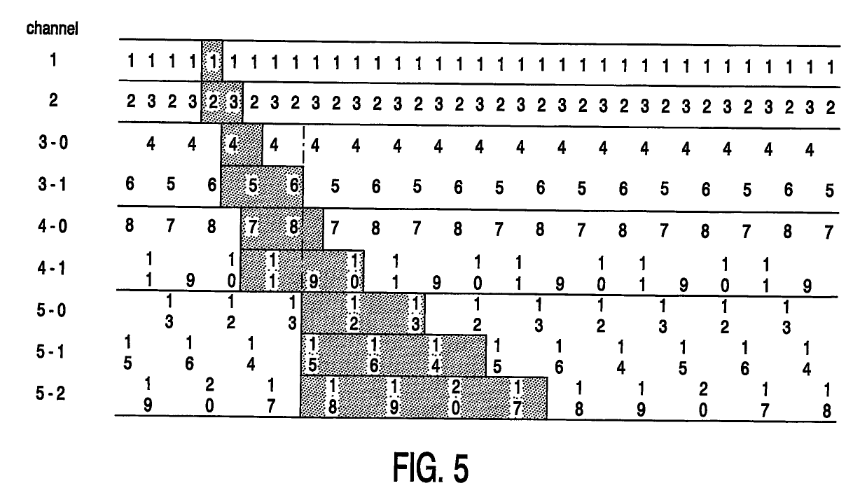

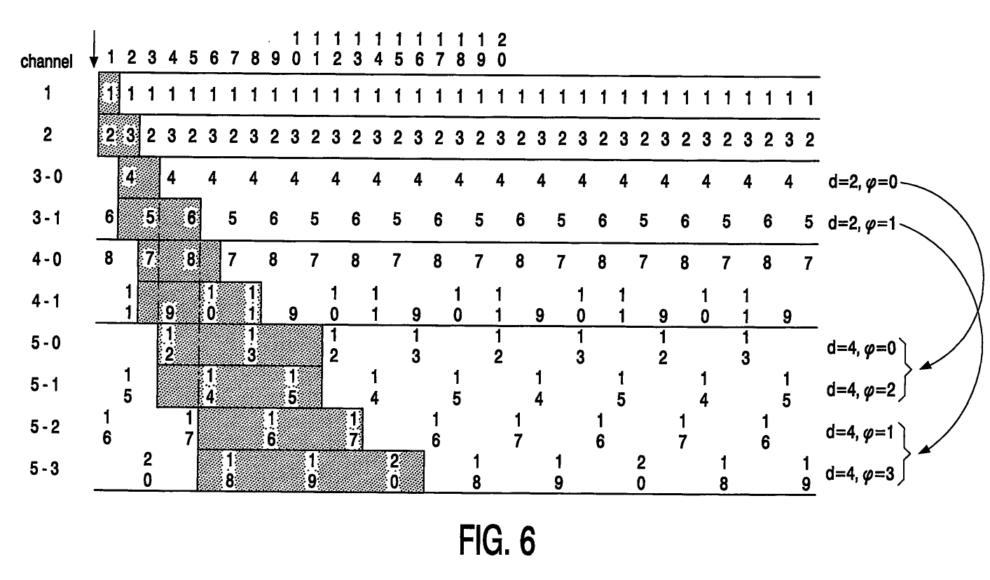

In the known Pagoda broadcasting scheme, channel i, i>r, is started when channel i-r has ended, i.e., when all sub-channels in channel i-r have ended. A drawback of this is that the reception capacity is not always fully utilized, as illustrated in FIG. 5. In the figure, sub-channel 0 of channel 3 takes only two time units, but channel 5 only starts four time units after the start of channel 3. As a result, only one block is received in the time slot right after the end of sub-channel 0 of channel 3 (as block 4 has already been received), hence the reception capacity is not fully used. An improved schedule according to the invention is obtained by starting already some of the sub-channels of channel 5 when sub-channel 0 of channel 3 has ended, and the remaining sub-channels of channel 5 when sub-channel 1 of channel 3 has ended, as illustrated in FIG. 6. Although there is no impact in this small example on the total number of blocks (and hence on the waiting time), the impact for larger schemes is substantial, as will become clear from Table 3.

In a preferred embodiment, the number of sub-channels of channel i, i>r, is an integer multiple Mᵢ₋ᵣ of the number of sub-channels of channel i-r. To this end, the number of sub-channels may need to be changed compared to the original Pagoda system. In the example of FIG. 6, four sub-channels are used for channel 5 instead of three. By using a multiple Mᵢ it becomes possible to start Mᵢ sub-channels of channel i+r in response to reaching the end of a sub-channel of channel i, recalling that Mᵢ sub-channels of channel i+r have the same capacity as one sub-channel of channel i (the channels having equal capacity). In this way, all reception capacity can be fully utilized.

In a preferred embodiment, the protocol is such that after ending a sub-channel in channel i-r, the newly started sub-channels in channel i fall in the same time units (time slots), in order not to conflict with blocks transmitted in the other sub-channels of channel i-r. In the example of FIG. 6, this means that sub-channels 0 and 1 of channel 5 must use the same time units as allocated to sub-channel 0 of channel 3. The latter time units are the even time units, i.e, time units x with x mod 2=0, so the time units x with x mod 4=0 are allocated to sub-channel 0 of channel 5, and the time units x with x mod 4=2 are allocated to sub-channel 1 of channel 5. In this way, the number of channels to be tapped simultaneously never exceeds r. More formally, a phasing φᵢⱼε{0, . . . , dᵢ−1} is introduced for each sub-channel j=0, . . . , dᵢ−1 of channel i. For channels i=1. . . ,r, the number dᵢ of channels can be chosen around its target value of equation (1), without any additional restriction. The phasing of the sub-channels of channel i are simply assigned by
φᵢⱼ=j.

The start time of sub-channel j of channel i=1. . . ,r is the same as in the original Pagoda NVoD schedule, i.e.,
sᵢⱼ=sᵢ=1,
and also the number of blocks per sub-channel is calculated in the original way.

For channels i>r, the number dᵢ of channels can again be chosen around its target value of equation (1), but now with the extra restriction that it preferably is a multiple of dᵢ₋ᵣ. Next, whenever a sub-channel j′ of channel i-r ends, which happens in time unit e_{i-r j′}, we start Mᵢ₋ᵣ=dᵢ/dᵢ₋ᵣ new sub-channels in channel i, numbered j=j′Mᵢ₋ᵣ, . . . ,(j′+1)Mᵢ₋ᵣ−1, which all get a start time
sᵢⱼ=e_{i-r,j′}+1.

The phasing of these new sub-channels is given by
φᵢⱼ=φ_{i-r,j′}+kdᵢ₋ᵣ,
for j=j′Mᵢ₋ᵣ+k with k=0. . . ,Mᵢ₋ᵣ−1. This indeed gives that the new sub-channels fall in the same time units as the ended sub-channel, as
φᵢⱼmoddᵢ₋ᵣ=φ_{i-r, j′}

Next, the number of blocks in sub-channel j=j′Mᵢ₋ᵣ, . . . ,(j′+1)Mᵢ₋ᵣ−1 is basically calculated in the same way as in the original schedule, i.e., it is set to

$${n}_{ij} = {p}_{ij} = ⌊ \frac{o + {l}_{ij} - ( {s}_{ij} - 1 )}{{d}_{i}} ⌋ .$$

The effect of the above modification is especially significant in case the number r of channels that can be received is low, e.g., for r=2, as can be see in table 3. The number of blocks in which to split a movie can be over a factor four higher in this example. Moreover, the base of the power series to which the sequence converges increases significantly. For r=2, it increases from 1.75 to 2.20. For r=3 it increases from 2.42 to 2.55, and for r=4 from 2.62 to 2.66. As can be seen, the impact is highest for a small value of r, which is caused by the fact that wasting reception capacity is (relatively) more severe for a small value of r.

TABLE 3

| | Original Pagoda schedule | Improved Schedule |
|---|---|---|
| i = 1 | 1 | 1 |
| i = 2 | 3 | 3 |
| i = 3 | 6 | 6 |
| i = 4 | 11 | 11 |
| i = 5 | 21 | 21 |
| i = 6 | 42 | 42 |
| i = 7 | 81 | 85 |
| i = 8 | 148 | 172 |
| i = 9 | 269 | 357 |
| i = 10 | 478 | 754 |
| i = 11 | 841 | 1607 |
| i = 12 | 1487 | 3477 |
| i = 13 | 2627 | 7585 |
| i = 14 | 4617 | 16621 |
| i = 15 | 8058 | 36570 |

It should be noted that although it is preferred that dᵢ is an integer multiple of dᵢ₋ᵣ, for i>r, actually, the schedule can be somewhat more refmed. For instance, in the example of FIG. 6, it is also possible to start two new sub-channels in channel 5 when sub-channel 0 of channel 3 ends, and three new sub-channels in channel 5 when sub-channel 1 of channel 3 ends. Hence, channel 5 may also have 5 sub-channels, of which the first two have a period of 4 and phasings 0 and 2, respectively, and the last three have a period of 6 and phasings 1, 3, and 5, respectively. In this way, the newly started sub-channels still occupy the same time units as the sub-channel that just ended, but the constraint on the number of sub-channels is relaxed. The improvement in the schedule realized in this way is only marginal (experiments give an increase of only 1% in the number of blocks, or no increase at all).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. In the system claims enumerating several means, several of these means can be embodied by one and the same item of hardware. The computer program product may be stored/distributed on a suitable medium, such as optical storage, but may also be distributed in other forms, such as being distributed via the network of the broadcasting system, Internet or wireless telecommunication systems.

1. A broadcast system including a plurality of broadcast receivers and a broadcasting device for broadcasting titles to the broadcast receivers using a near-video-on-demand broadcasting protocol;
the broadcasting device being operative to broadcast data blocks of a title via c parallel equal capacity channels of the broadcast system, where each broadcast channel is associated with a respective sequential channel number; a plurality of the broadcast channels including a plurality of time-sequentially interleaved sub-channels; the number of sub-channels in a channel being monotonous non-decreasing with the channel number; the sub-channels in a channel being associated with a respective sequential sub-channel number; the title being divided in a plurality of consecutive data block sequences; each block sequence being assigned to one respective sub-channel according to the channel number and sub-channel number; the broadcasting device being operative to repeatedly broadcast each block sequence in the assigned sub-channel;
the broadcast receiver having a capacity to simultaneously receive all sub-channels of a plurality r (1<r≦c) of the channels; the broadcast receiver being operative to receive a title by starting reception of all sub-channels of the sequentially lowest r channels and each time in response to having received all blocks of the block sequence of a sub-channel of channel i terminate reception of the sub-channel in channel i and start reception of at least one sub-channel of channel r+i until all block sequences have been received.

2. A broadcast system as claimed in claim 1, wherein the broadcasting device is operative to broadcast the data blocks assigned to the parallel channels synchronously using equal-duration time slots; each sub-channel of channel i being associated with at least one sub-channel of channel r+i whose blocks are only being broadcast during time-slots used for broadcasting the associated sub-channel of channel i; the broadcast receiver being operative, in response to having received all blocks of the block sequence of a sub-channel of channel i, to start reception of an associated sub-channel of channel r+i (i≧2).

3. A broadcast system as claimed in claim 1, wherein channel i+r has a multiple Mᵢ of sub-channels of the number of sub-channels in channel i; each sub-channel of channel i being associated with Mᵢ sub-channels of channel r+i whose blocks are only being broadcast during time-slots used for broadcasting the associated sub-channel of channel i; the broadcast receiver being operative in response to having received all blocks of the block sequence of a sub-channel of channel i start reception of the Mi associated sub-channels of channel r+i (i≧1).

4. A broadcast system as claimed in claim 1 wherein the near-video-on-demand protocol is a fixed-delay pagoda broadcasting protocol.

5. A broadcast receiver for use in a broadcast system as claimed in claim 1 wherein a broadcasting device uses a near-video-on-demand broadcasting protocol for broadcasting data blocks of a title via c parallel equal capacity channels of the broadcast system, where each broadcast channel is associated with a respective sequential channel number; a plurality of the broadcast channels including a plurality of time-sequentially interleaved sub-channels; the number of sub-channels in a channel being monotonous non-decreasing with the channel number; the sub-channels in a channel being associated with a respective sequential sub-channel number; the title being divided in a plurality of consecutive data block sequences; each block sequence being assigned to one respective sub-channel according to the channel number and sub-channel number; the broadcasting device being operative to repeatedly broadcast each block sequence in the assigned sub-channel;
the broadcast receiver having a capacity to simultaneously receive all sub-channels of a plurality r (1<r≦c) of the channels; the broadcast receiver being operative to receive a title by starting reception of all sub-channels of the sequentially lowest r channels and each time in response to having received all blocks of the block sequence of a sub-channel of channel i terminate reception of the sub-channel in channel i and start reception of at least one sub-channel of channel r+i until all block sequences have been received.

6. A method of receiving broadcast data in a broadcast receiver for use in a broadcast system as claimed in claim 1 wherein a broadcasting device uses a near-video-on-demand broadcasting protocol for broadcasting data blocks of a title via c parallel equal capacity channels of the broadcast system, where each broadcast channel is associated with a respective sequential channel number; a plurality of the broadcast channels including a plurality of time-sequentially interleaved sub-channels; the number of sub-channels in a channel being monotonous non-decreasing with the channel number; the sub-channels in a channel being associated with a respective sequential sub-channel number; the title being divided in a plurality of consecutive data block sequences; each block sequence being assigned to one respective sub-channel according to the channel number and sub-channel number; the broadcasting device being operative to repeatedly broadcast each block sequence in the assigned sub-channel;
the broadcast receiver having a capacity to simultaneously receive all sub-channels of a plurality r (1<r≦c) of the channels;
the method including receiving a title by:
starting reception of all sub-channels of the sequentially lowest r channels; and
each time in response to having received all blocks of the block sequence of a sub-channel of channel i terminating reception of the sub-channel in channel i and starting reception of at least one sub-channel of channel r+i until all block sequences have been received.

7. A computer program product operative to cause a processor to perform the steps of claim 6.
